(19) United States
(12) Patent Application Publication
(10) Pub. No.: US 2020/0171389 A1
(43) Pub. Date: Jun. 4, 2020

(54) DYNAMIC VIDEO GAME AVAILABILITY AND REWARDS

(71) Applicants: Josiah Eatedali, Los Angeles, CA (US); Robert Schonfeld, Sherman Oaks, CA (US)

(72) Inventors: Josiah Eatedali, Los Angeles, CA (US); Robert Schonfeld, Sherman Oaks, CA (US)

(21) Appl. No.: 16/579,606

(22) Filed: Sep. 23, 2019

Related U.S. Application Data
(60) Provisional application No. 62/772,826, filed on Nov. 29, 2018.

(51) Int. Cl. A63F 13/67

(52) U.S. Cl. CPC A63F 13/67

(57) ABSTRACT

Video game related products may be made available for procurement to game players based on in-game accomplishments. In some embodiments the video game related products may be video games not generally available to the public, or versions of video game not generally available to the public.

### CROSS REFERENCE TO RELATED APPLICATION

This application claims the benefit of the filing date of U.S. Provisional Patent Application No. 62/772,826, filed on Nov. 29, 2018, the disclosure of which is incorporated by reference herein.

### BACKGROUND OF THE INVENTION

The present invention relates generally to video games, and more particularly to the dynamic adjustment of availability of access to video games related products.

Video games provide a source of entertainment for many. Video games often provide an interactive activity that can be interesting and challenging, and may allow game players to control game characters engaged in various simulated activities, including real-life activities that may otherwise be unavailable to the game player. Moreover, the game characters may utilize personal equipment not readily available in the real world to game players, allowing the game players simulated use of a variety of real world items.

Different video games may vary in subject matter presented, styles of play, difficulty, and in a host of other ways. Different game players may have different levels of enjoyment in playing different types of games, in ways that may vary across a wide spectrum. Even for game players that prefer a particular type of game, the enjoyment those players may experience in playing the game may vary widely across skill levels of the game players, and the sum of their experiences in playing a particular game. For example, undue complexity in offerings and options may decrease game play enjoyment for a game player during beginning periods of game play. Similarly, a surfeit of possibilities, whether in equipment or scenarios, may also overload game players. Gauging a number of offerings and options relating to video game play that enhances rather than detracts from game play may be difficult.

### BRIEF SUMMARY OF THE INVENTION

Some embodiments may provide for dynamic presentation of offering and options for video game play. In some embodiments video game play scenarios may be offered to game players based on one or more indications of skill and/or experience of the game players. In some embodiments the indications of skill and/or experience are determined based on game play accomplishments of one or more virtual game characters controlled by a game player. In some embodiments the game play accomplishments are accomplishments of a virtual game character in a video game. In some embodiments the game play accomplishments are accomplishments of one or more virtual game characters in one or more video games.

In some embodiments the game play accomplishments are predetermined game play accomplishments. In some embodiments the predetermined game play accomplishments include predetermined game play accomplishments with respect to play of the video game generally. In some embodiments the predetermined game play accomplishments are changed over time. In some embodiments the predetermined game play accomplishments with respect to play of the video game generally include one, some, or all of attaining a predetermined game play score, overcoming a predetermined percentage of game play challenges, and/or playing of the game a predetermined number of hours. In some embodiments the predetermined game play accomplishments include predetermined game play accomplishments with respect to particular aspects of the video game. In some embodiments the predetermined game play accomplishments with respect to particular aspects of the video game include attainment of a predetermined number of a predetermined accomplishment utilizing a predetermined item of virtual equipment for the virtual game character.

In some embodiments the game play accomplishments comprises a level of accomplishments compared to levels of accomplishments of other game players.

In some embodiments game players who achieve the accomplishments are provided availability of procurement of additional scenarios or expansions for the video game. In some embodiments game players who achieve the accomplishments are provided availability of procurement of one or more other video games. In some embodiments game players who achieve the accomplishments are provided availability of procurement of access for play of one or more video games not generally available for play. In some embodiments game players who achieve the accomplishments are provided availability of procurement of items for use in the video game or one or more other video games. In some embodiments game players who achieve the accomplishments are provided availability of procurement of items for use in a video game, at a discounted price in some embodiments. In some embodiments game players who achieve the accomplishments are provided availability of procurement of one or more other video games, additional scenarios, or expansions of the video game or the one or more other video games, at a discounted price in some embodiments.

Some embodiments provide a method for providing access to procurement of video game related products, comprising: monitoring game play activities of play of one or more video games by a game player, in which one or more game characters are controlled by the game player based on user inputs to a game device; determining that the game play activities indicate achievement of a game play accomplishment; and in response to determining that the game play activities indicate achievement of a game play accomplishment, making a video game related product offering available for procurement.

These and other aspects of the invention are more fully comprehended upon review of this disclosure.

### BRIEF DESCRIPTION OF THE FIGURES

FIG. 1 is a flow diagram of a process for modifying availability of video game options based on video game play accomplishments, in accordance with aspects of the invention.

FIG. 2 illustrates a networked video game system in accordance with aspects of the invention.

FIG. 3 is a flow diagram of a further process for modifying availability of video game options based on video game play accomplishments, in accordance with aspects of the invention.

FIG. 4 illustrates records of information of game player accomplishments and reward levels, in accordance with aspects of the invention.

FIG. 5 is a flow diagram of a process for determining dynamic updates of accomplishment levels, in accordance with aspects of the invention.

### DETAILED DESCRIPTION

In some embodiments availability of video games and/or virtual video game goods is selectively made available to particular game players based on in-game accomplishments of the particular game players. In some embodiments the in-game accomplishments are predetermined. In some embodiments the in-game accomplishments may dynamically change based on play of game players generally.

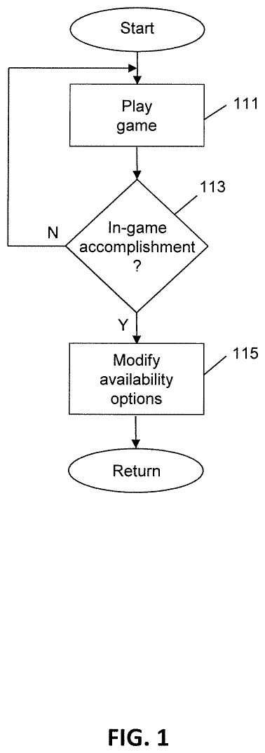

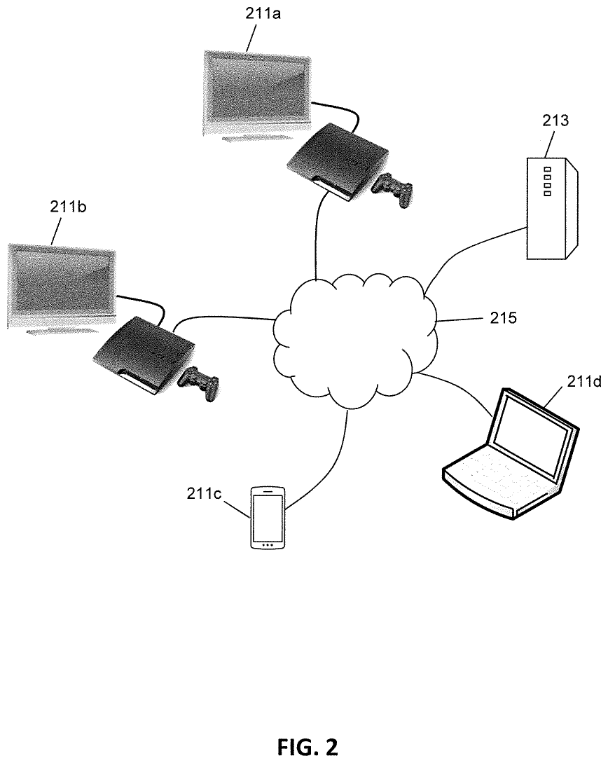

FIG. 1 is a flow diagram of a process for modifying availability of video game related products based on video game play accomplishments, in accordance with aspects of the invention. In some embodiments the process, or part of the process, is performed by a server. In some embodiments the process, or part of the process, is performed by a game device. In some embodiments the process is performed by one or more processors, for example configured by program instructions. In some embodiments the process is performed by a system, for example the system of later discussed FIG. 2, or one or more components of the system of FIG. 2.

In block 111 play of a video game occurs. In some embodiments play of the video game is accomplished with the user providing user inputs to a game device, for example by way of a game controller or other user input device, to control a game character in and interacting with a virtual world. In some embodiments the video game is a multi-player video game, and the game device provides information to a game server as to status of the game and game character, with the game device also receiving from the game server status of the game and other game characters controlled by other game players.

In block 113 the process determines if an in-game accomplishment has occurred that should result in availability of a video game related product. In some embodiments an in-game accomplishment has occurred if a game character, controlled by a game player, has achieved one or more predetermined accomplishments. In some embodiments a predetermined accomplishment may be performing a specified number of actions with a specified tool. For example, in some embodiments the predetermined accomplishment may comprise vanquishing a predetermined number of opponents using a particular virtual weapon, and in some embodiments the predetermined accomplishment may comprise vanquishing a predetermined number of opponents using a particular style of play. For example, in some embodiments the opponents may be vanquished using a sniper rifle, or the opponents may be vanquished using a sniper style of play. In some embodiments the predetermined accomplishment may be reaching a predetermined score. In some embodiments the predetermined accomplishment may be vanquishing a predetermined percentage of available opponents in the game. In some embodiments the predetermined accomplishment may be succeeding in a specified percentage of goals defined for the game. In some embodiments an in-game accomplishment has occurred if a game player has played the video game a predetermined number of hours. In some embodiments an in-game accomplishment has occurred if a game player has played a plurality of predetermined video games a total of a predetermined number of hours. In some embodiments an in-game accomplishment has occurred if a game character controlled by the game player is in a highest percentage of a metric tracked for all game players. In some embodiments the metric may be updated or tracked periodically. In some embodiments, for example, the metric may be score, in some embodiments the metric may be opponents vanquished, and in some embodiments the metric may be accuracy in use of particular tools.

In some embodiments the game server determines if the in-game accomplishment has occurred. In some embodiments the game server receives information from game devices as to whether a game player is playing the video game and as to game activities of a game character controlled by the game player, and uses that information to determine if the in-game accomplishment has occurred.

In some embodiments the game device determines if the in-game accomplishment as occurred. In some embodiments the game device receives information from a server, for example the game server, as to what activities of the game character and/or game player may qualify as in-game accomplishments. In such embodiments, the game device may transmit a notification to the game server, or other server, when an in-game accomplishment has occurred, and, in some embodiments, an indication of which in-game accomplishment has occurred.

If an in-game accomplishment has occurred, the process proceed to block 115, otherwise the process returns to block 111.

In block 115 the process modifies availability of video game related products for procurement. In some embodiments the process makes a video game related product available for procurement, in response to occurrence of the in-game accomplishment. In some embodiments the process makes the video game related product available for procurement by the game player. In some embodiments the process makes the video game related product available for procurement by a group of game players. In some embodiments the game player is a member of the group of game players. In some embodiments the group is a group for a social media application. In some embodiments the group is comprised of, or consists of in some embodiments, team members of a team for the video game. In some embodiments the game player is member of the team.

In some embodiments the video game related product is a video game. In some embodiments the video game related product is a new version of a video game. In some embodiments the video game related product is a video game related product to be available for procurement by the general public at a future time. In some embodiments the video game related product is one, or more, in-game virtual items for use in a video game. In some embodiments the video game related product relates to the in-game accomplishment. For example, if the in-game related accomplishment is performed using a sniper rifle, or by way of a sniper style of play, the video game related product may be a sniper scenario or sniper expansion for a video game. In some embodiments the video game related product is an additional scenario for a video game. In some embodiments the video game related product is an expansion for a video game. In some embodiments the video game related product is made available at a discounted price.

In some embodiments the video game related product may be made available for procurement by presentation of the video game related product in a portion of a virtual store, (which may be, for example, an in-game or web-based store), for example a portion of the store only accessible to those to whom the product is to be made available. In such embodiments, the game server, or other server, may provide information to a server providing the web-based store indicating products and game players to whom the products should be made available. In some embodiments a code or password may be provided to those to whom the product is to be made available, with use of the code or password with respect to the web-based store allowing for procurement of the video game related product. For example, the game server may transmit the code or password to game devices associated with game players to whom the product is to be made available.

The process thereafter returns.

FIG. 2 is a semi-block diagram of a system in accordance with aspects of the invention. The system includes a plurality of game devices 211a-d coupled to each other and a game server 213 over a network 215, which may be for example the Internet. The game devices, and the server, may be considered compute devices. In some embodiments the game server may be a plurality of servers. In some such embodiments one of those servers may perform functions relating to play of video games, while another of those servers may perform functions relating to determining availability of video game related products for procurement.

The game devices 211a and 211b are shown as including a game console having at least one processor, a game controller, and a display. The game device 211c is shown as a smartphone, including at least one processor, a display device, and a touchscreen. The game device 211d is shown as a personal computer, of the laptop type in FIG. 2. More generally, in various embodiments the game devices may instead or in addition comprise a personal computer, a tablet computer, a smart phone, and/or some other compute device, each configured for video game play. In addition, for purposes of illustration, only a small number of game devices are shown in FIG. 2, in most embodiments the number of game devices may be over a thousand, and may be an order of magnitude or orders of magnitude greater than that. In some embodiments, however, the game devices may only consist of game consoles.

The game devices are configured, or configurable, for play of a video game, for example a single player and/or multi-player video game. During play of the video game, a game player utilizes the game controller or other input devices of a game device to control actions of a game character associated with the game player. The game character, responsive to commands provided by the game controller, is in and interacts with a virtual world and its other inhabitants, some of whom may be game characters controlled by other game players and some of whom may be game characters controlled by the video game itself. In some embodiments the game devices are configured to provide information regarding whether game play is occurring, and/or status of game play, to the game server. In some embodiments, for example in multi-player video games, the game server may receive information regarding game play status from the game devices, with the game server distributing the game play status to the various game devices. In some embodiments the game server may instead receive requests for game character actions from the game devices, with the game server determining game play status and distributing information regarding game play status to the game devices.

In some embodiments the game server monitors information received from the game devices regarding game play events and status, and determines if an in-game accomplishment occurred that should result in availability of a video game related product. In some embodiments the game server makes the product available for procurement by the game player responsible for the accomplishment, and/or other entities such as group members or team members in some embodiments. In some embodiments the game server may instead provide a notification to another server to make the product available for procurement to the game player, and/or entities in some embodiments.

In some embodiments the game server, or other server, provides the game devices information as to in-game accomplishments that should result in availability of video game related products. In some embodiments the game server, or other server, provides information as to criteria for qualifying as such an in-game accomplishment. In such embodiments, the game devices may determine if an in-game accomplishment occurred that should result in availability of a video game related product. In some such embodiments the game devices may provide information to the game server, or some other server, that the in-game accomplishment occurred. The game server, or some other server, may make the video game related products available for procurement by the game player responsible for the accomplishment, and/or other entities such as group members or team members in some embodiments.

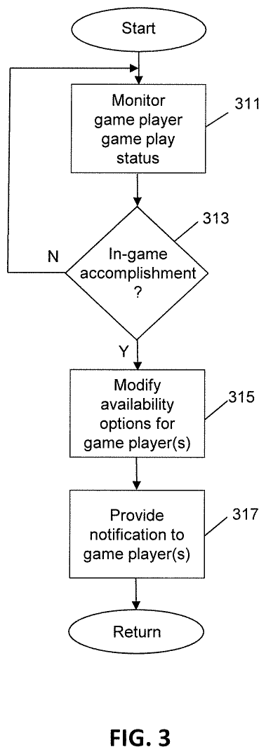

FIG. 3 is a flow diagram of a further process for modifying availability of video game options based on video game play accomplishments, in accordance with aspects of the invention. In some embodiments the process, or part of the process, is performed by a server, for example the server of FIG. 2. In some embodiments the process is performed by one or more processors, for example configured by program instructions.

In block 311 the process monitors information regarding game play events and status of play of one or more video games. In some embodiments the server receives information from game devices regarding game play events and status as part of providing multi-player game play of the video games. In some embodiments the server receives information from game devices regarding game play events and status, independent of providing multi-player game play. In some embodiments the server provides requests to the game devices that the game devices notify the server upon occurrence of particular events, or changes in particular game play status, with the game devices providing the server such notifications.

The server may monitor the information regarding game play events and status with respect to events and status that may indicate that an in-game accomplishment has occurred that should result in availability of a video game related product. In some embodiments such an in-game accomplishment may occur if game play events and status indicates that predetermined criteria has been met as part of game play. In some embodiments the predetermined criteria may be with respect to levels of achievement of a game character controlled by a game player, and/or with respect to extent of play by the game player. The levels of achievement may be general in some embodiments, for example a total point score, or more specific in some embodiments, for example a number of opponents vanquished by the game character in a specific manner or with a specific tool. In addition or instead, in some embodiments the predetermined criteria may be with respect to levels of achievement of the game character as compared to levels of achievement of other game characters controlled by other game players.

In block 313 the process determines if an in-game accomplishment has occurred that should result in availability of a video game related product. In some embodiments the server determines an in-game accomplishment has occurred if a game character, controlled by a game player, has achieved one or more predetermined accomplishments. In some embodiments a predetermined accomplishment may be performing a specified number of actions with a specified tool. For example, in some embodiments the predeteiniined accomplishment may comprise vanquishing a predetermined number of opponents using a particular virtual weapon. In some embodiments the predetermined accomplishment may be reaching a predetermined score. In some embodiments the predetermined accomplishment may be vanquishing a predetermined percentage of available opponents in the game. In some embodiments the predetermined accomplishment may be succeeding in a specified percentage of goals defined for the game. In some embodiments an in-game accomplishment has occurred if a game player has played the video game a predetermined number of hours. In some embodiments an in-game accomplishment has occurred if a game player has played a plurality of predetermined video games a total of a predetermined number of hours. In some embodiments an in-game accomplishment has occurred if a game character controlled by the game player is in a highest percentage of a metric tracked for all game players. In some embodiments the metric may be updated or tracked periodically. In some embodiments, for example, the metric may be score, in some embodiments the metric may be opponents vanquished, and in some embodiments the metric may be accuracy in use of particular tools.

In block 315 the process modifies availability of video game related products for procurement. In some embodiments the process makes a video game related product available for procurement, in response to occurrence of the in-game accomplishment. In some embodiments the process makes the video game related product available for procurement by the game player. In some embodiments the process makes the video game related product available for procurement by a group of game players. In some embodiments the game player is a member of the group of game players. In some embodiments the group is a group for a social media application. In some embodiments the group is comprised of or consists of in some embodiments, team members of a team for the video game. In some embodiments the game player is member of the team. In some embodiments the server makes the product available for procurement by the game player responsible for the accomplishment, and/or other entities such as group members or team members in some embodiments. In some embodiments the server may instead provide a notification to another server to make the product available for procurement to the game player, and/or entities in some embodiments.

In block 317 the process notifies the game player(s) that the video game related product has been made available for procurement by the game player(s). In some embodiments the server transmits a notification to a game device associated with each game player for whom the video game related product has been made available for procurement.

The process thereafter returns.

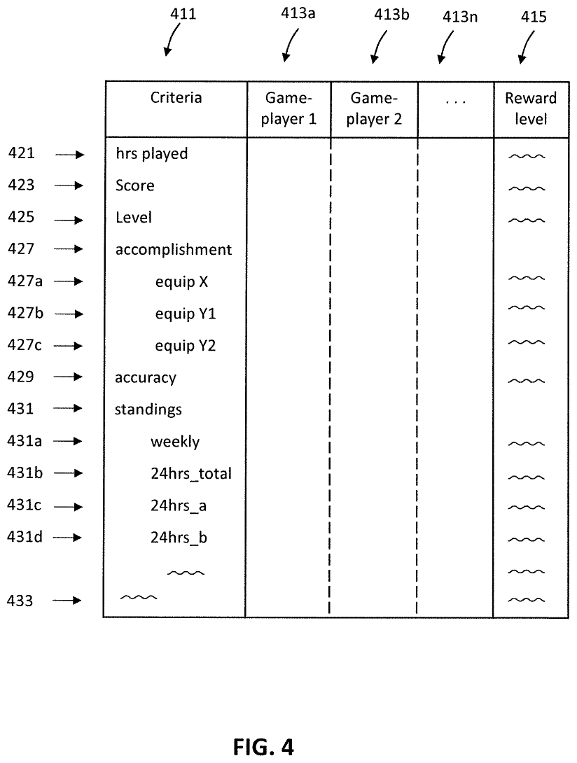

FIG. 4 illustrates records of information of game player accomplishments and reward levels, in accordance with aspects of the invention. In some embodiments the records are utilized in the processes of FIGS. 1 and/or 3 in determining whether an in-game accomplishment has occurred that should result in availability of a video game related product.

In FIG. 4, the records are for a plurality of criteria 411 for in-game accomplishments. The records include records indicating in-game status 413a-n for a plurality of game players pertaining to those criteria, and records indicating a reward (or comparison level) 415 for use in determining whether the game players achievement levels have met the levels required for an in-game accomplishment that should result in availability of a video game related product.

The criteria listed in FIG. 4 include hours played 421, game score 423, game character video game level 425, various specific game character accomplishments 427 (which in FIG. 4 are accomplishments using a first item of equipment (equip X) 427a, a second item of equipment in a first configuration (equip Y1) 427b, and the second item of equipment in a second configuration (equip Y2) 427c, game character accuracy 429, and game character position in various standings 431 (which in FIG. 4 are for standings determined weekly 431a, standings determined every 24 hours 431b, standings determined every 24 hours for a first particular sub-category (e.g. numbers of victories over opponents) 431c, and standings determined every 24 hours for a second particular sub-category (e.g. extent of movement divided by numbers of defeats by opponents). Fewer criteria may be provided in some embodiments. Conversely, other or a greater number of criteria may be provided in other embodiments, for example as indicated by an additional criteria 433 in FIG. 4.

For each game player, information for each of the criteria is maintained. For example, for a game player 1, a record for hour played by the game player is maintained, a record for a score of a game character under the control of the game player is maintained, and so on. Records for the same subjects are maintained for the other game players as well. FIG. 4 shows a column for records of the game player 1, a game player 2, and a game player n. In many embodiments there may be records for ten, hundred, thousands, or more game players. For many records, monitoring of game play status and events relating to just the game player may be sufficient. For example, determining hours played or a score of the game character under the control of the game player does not require reference to activities or status of other game players. For some records, however, determinations relating to other game. For example, determining a position in a weekly standings is a determination that involves reference to activities or status of other game players.

The reward (or comparison level) records identify a value for use in determining occurrence of an in-game accomplishment. For example, the reward records include a record for hours played, a record for a score, a record for a game character level, and so on. Each of the reward records indicate a level with which comparisons with corresponding game player records may be performed, in order to determine occurrence of an in-game accomplishment. For example, the reward record for hours played may indicate 1000, and game players whose records indicate that they have exceeded 1000 hours of play may be considered to have made an in-game accomplishment. Similarly, a reward record for weekly standings may indicate a value for a top 10%, and game players whose records indicate that they are in the top 10% of the weekly standing may be considered to have made an in-game accomplishment. In some embodiments the reward records may be changed over time.

In some embodiments a reward or comparison level may be maintained for each game player, such that different game players may have different levels at which an in-game accomplishment is considered to have occurred. In addition or instead, in some embodiments additional records may be maintained, to indicate how availability of video game related product procurement should be modified based on how the in-game accomplishment is made. For example, in some embodiments a first video game related product may be made available for procurement by a game player who has played a certain number of hours of a video game, and a second video game related product may be made available for procurement by the game player if a game character controlled by the game player has reached a certain game level. In addition, in some embodiments a flag may be maintained to indicate whether a game player is eligible to be considered to have made an in-game accomplishment with respect to particular items. For example, in some embodiments a game player may only be eligible to be considered to have made an in-game accomplishment with respect to number of hours played only once.

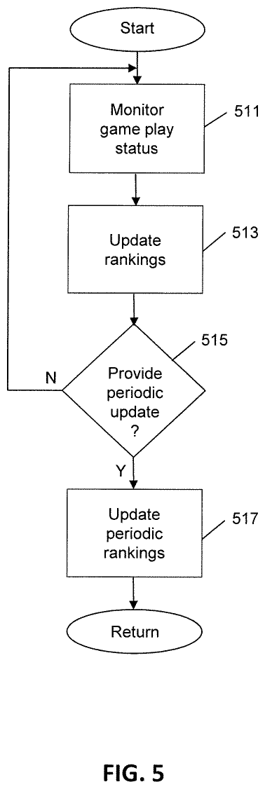

FIG. 5 is a flow diagram of a process for determining dynamic updates of accomplishment levels, in accordance with aspects of the invention. In some embodiments the process, or part of the process, is performed by a server, for example the server of FIG. 2. In some embodiments the process is performed by one or more processors, for example configured by program instructions.

In block 511 the process monitors information regarding game play events and status of play of one or more video games. In some embodiments the server receives information from game devices regarding game play events and status as part of providing multi-player game play of the video games. In some embodiments the server receives information from game devices regarding game play events and status, independent of providing multi-player game play. In some embodiments the server provides requests to the game devices that the game devices notify the server upon occurrence of particular events, or changes in particular game play status, with the game devices providing the server such notifications.

In some embodiments the server may monitor the information regarding game play events and status with respect to items relevant to rankings maintained by the server. For example, in some embodiments the server may maintain rankings for game character score on one, some, or all of a daily basis, weekly basis, and/or overall. Similarly, in some embodiments the server may maintain rankings for number of opponents vanquished by a game character using a particular item of equipment, or rankings for a variety of other matters.

In block 513 the process updates rankings for rankings that are maintained on a relatively constant basis. For example, a ranking of an overall high score may be maintained on a relatively constant basis. In some embodiments the process updates rankings by modifying values of records indicating game player status and/or records for reward values, for example the records discussed with respect to FIG. 4.

In block 515 the process determines if periodic rankings should be updated. For example, in some embodiments a 24 hour ranking may be updated only once every 24 hours at a predefined time, or updated once every hour in some embodiments. Similarly, a weekly ranking may updated only once a week on a predefined day and a predefined time, in some embodiments. If periodic rankings should be updated, the process continues to block 517, otherwise the process returns to block 511.

In block 517 updates the periodic rankings. In some embodiments the process updates rankings by modifying values of records indicating game player status and/or records for reward values, for example the records discussed with respect to FIG. 4.

The process thereafter returns.

Although the invention has been discussed with respect to various embodiments, it should be recognized that the invention comprises the novel and non-obvious claims supported by this disclosure.

What is claimed is:

1. A method for providing access to procurement of video game related products, comprising:
monitoring game play activities of play of one or more video games by a game player, in which one or more game characters are controlled by the game player based on user inputs to a game device;
determining that the game play activities indicate achievement of a game play accomplishment; and
in response to determining that the game play activities indicate achievement of the game play accomplishment, making a video game related product offering available for procurement.

2. The method of claim 1, wherein the one or more video games is one video game, and wherein the one or more game characters is one game character.

3. The method of claim 2, wherein the game play accomplishment is a game play accomplishment of the one game character in the one video game.

4. The method of claim 3 wherein the game play accomplishment is any of a plurality of predetermined game play accomplishments.

5. The method of claim 4 wherein the predetermined game play accomplishments include predetermined game play accomplishments with respect to play of the video game generally.

6. The method of claim 5, wherein the predetermined game play accomplishments with respect to play of the video game generally include attaining a predetermined game play score.

7. The method of claim 5, wherein the predetermined game play accomplishments with respect to play of the video game generally include overcoming a predetermined percentage of game play challenges.

8. The method of claim 1, wherein the game play accomplishment is play of the one or more video games by the game player by more than a predetermined number of hours.

9. The method of claim 1, wherein the video game related product offering is a different version of one of the one or more video games.

10. The method of claim 1, wherein the video game related product offering is a different video game than the one or more video games.

11. The method of claim 1, wherein the video game related product offering comprises items for use in a one of the one or more video games.

12. The method of claim 1, wherein the video game related product offering comprises a video game at a discounted price.

13. The method of claim 3, wherein the game play accomplishments comprise a level of accomplishments compared to levels of accomplishments of other game players.

14. The method of claim 3, wherein the game play accomplishments include predetermined game play accomplishments with respect to particular aspects of the video game.

15. The method of claim 14, wherein the predetermined game play accomplishments with respect to particular aspects of the video game include attainment of a predetermined number of a predetermined accomplishment utilizing a predetermined item of virtual equipment for the game character.
